(19) United States
(12) Patent Application Publication
(10) Pub. No.: US 2025/0089938 A1
(43) Pub. Date: Mar. 20, 2025

(54) COOKING UTENSIL

(71) Applicant: KABUSHIKI KAISYA LEBEN, Yokohama-shi (JP)

(72) Inventor: Atsushi TAKABU, Kanagawa (JP)

(21) Appl. No.: 18/963,741

(22) Filed: Nov. 28, 2024

Related U.S. Application Data
(63) Continuation of application No. PCT/JP2024/020002, filed on May 31, 2024.

(30) Foreign Application Priority Data
Jun. 2, 2023 (JP) 2023-091647

(51) Int. Cl. A47J 37/04; A47J 43/18

(52) U.S. Cl. CPC A47J 37/04; A47J 43/18

(57) ABSTRACT

The cooking utensil includes a grip portion held by the user, connected to a piercing portion and configured to pierces food. The piercing portion has a plurality of arms on the same plane, with at least one arm having a reverse hook at its tip, where the reverse hook includes an inclined portion forming an acute angle from the tip of the arm and a stopper portion. At least one of the arms is rotatable relative to the other arms within the same plane.

### TECHNICAL FIELD

The present invention relates to cooking utensils. This invention claims priority based on Japanese Patent Application No. 2023-091647, filed on Jun. 2, 2023, and incorporates the content of that application by reference for designated countries where incorporation by reference is recognized.

### BACKGROUND ART

There are skewers used to hold food by piercing it, such as those used in barbecues.

Patent Document 1 describes a replaceable multi-tool designed for use by piercing food.

### CITATION LIST

### Patent Literature

PTL 1: JP 2020-31536 A

### SUMMARY OF INVENTION

### Problems to be Solved by the Invention

In recent years, with the diversification of peelers, peelers are not only used for peeling the skin off food but also for processing food by shaving it. When processing food, it is often necessary to stabilize the food, especially when the food has a spherical shape or is otherwise difficult to hold by hand. In some cases, the food is skewered to secure it. In such cases, if the peeler is used away from the user, there is a risk of injury to the hand holding the food, depending on the direction in which the peeler is used. Therefore, if the peeler is used towards the user, the peeler is pulled towards the user, which can prevent injury.

However, when the food is oriented towards the user using a skewer like the replaceable multi-tool in Patent Document 1, the food tends to slip off the skewer more easily.

Accordingly, the present invention aims to provide a cooking utensil that can easily pierce food and prevent the food from slipping off.

### Means for Solving the Problems

The present application includes several means to solve at least some of the above problems. As an example, a cooking utensil according to one aspect of the present invention includes a grip portion held by the user and a piercing portion connected to the grip portion and configured to pierce food. The piercing portion has a plurality of arms on the same plane, with at least one of the arms having a reverse hook at its tip. The reverse hook includes an inclined portion and a stopper portion forming an acute angle from the tip of the arm. At least one of the arms is rotatable relative to the other arms within the same plane.

The rotatable arm may include a lever on the side opposite the direction in which the arm extends.

### Effects of the Invention

According to the present invention, it is possible to provide a cooking utensil that easily pierces food and prevents the food from slipping off.

### BRIEF DESCRIPTION OF THE DRAWINGS

FIG. 1A, FIG. 1B, FIG. 2A, FIG. 2B, FIG. 3A and FIG. 3B are diagrams showing an example of the cooking utensil 1 according to the first embodiment.

FIG. 4A and FIG. 4B are diagrams showing a first modified example of the cooking utensil 1 according to the first embodiment.

FIG. 5A, FIG. 5B and FIG. 5C are diagrams showing a second modified example of the cooking utensil 1 according to the first embodiment.

FIG. 6 is a diagram showing a third modified example of the cooking utensil 1 according to the first embodiment.

FIG. 7 is a diagram showing a fourth modified example of the cooking utensil 1 according to the first embodiment.

FIG. 8A, FIG. 8B and FIG. 8C are diagrams showing an example of the use of the cooking utensil 1 according to the fourth modified example of the first embodiment.

FIG. 9A and FIG. 9B are diagrams showing a fifth modified example of the cooking utensil 1 according to the first embodiment.

FIG. 10A and FIG. 10B are diagrams showing an example of the use of the cooking utensil 1 according to the fifth modified example of the first embodiment.

FIG. 11 is a diagram showing a sixth modified example of the cooking utensil 1 according to the first embodiment.

FIG. 12A and FIG. 12B are diagrams showing a modification of the sixth modified example of the cooking utensil 1 according to the first embodiment.

FIG. 13A, FIG. 13B and FIG. 13C are diagrams showing an example of the cooking utensil 2 according to the second embodiment.

FIG. 14A, FIG. 14B, FIG. 14C and FIG. 14D are diagrams showing a first modified example of the cooking utensil 2 according to the second embodiment.

FIG. 15A, FIG. 15B, FIG. 15C and FIG. 15D are diagrams showing a second modified example of the cooking utensil 2 according to the second embodiment.

FIG. 16A, FIG. 16B, and FIG. 16C are diagrams showing another example of the use of the cooking utensil 2 according to the second modified example.

FIG. 17 is a diagram showing a third modified example of the cooking utensil 2 according to the second embodiment.

FIG. 18 is a diagram showing an example of the cooking utensil 2 according to the third modified example.

FIG. 19A, FIG. 19B, FIG. 19C and FIG. 19D are diagrams showing a fourth modified example of the cooking utensil 2 according to the second embodiment.

FIG. 20A and FIG. 20B are diagrams showing another example of the use of the cooking utensil 2 according to the fourth modified example.

### DESCRIPTION OF EMBODIMENTS

Hereinafter, examples of embodiments of the present invention will be described with reference to the drawings. In the following embodiments, the same reference numerals as those previously mentioned may be used for common components, and their descriptions may be omitted. Additionally, when referring to the shape, positional relationship, and other aspects of components, the description should be understood to include those substantially similar unless explicitly specified otherwise or unless it is clearly understood from the context that they should be different.

### Embodiment 1

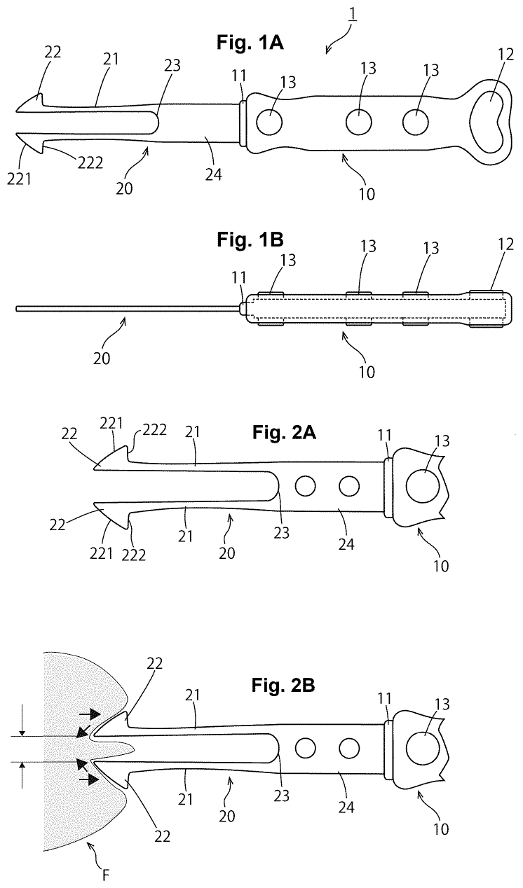

FIGS. 1A to 3B illustrate an example of the cooking utensil 1 according to the first embodiment. FIG. 1A is a front view of the cooking utensil 1, FIG. 1B is a partial perspective view of the left side of the cooking utensil 1, FIG. 2A is a partial front view of the cooking utensil 1 with the reverse hook portion 22 facing outward, FIG. 2B shows the state where the cooking utensil 1 is inserted into food, FIG. 3A is a partial front view of the cooking utensil 1 with the reverse hook portion 22 facing inward, and FIG. 3B shows the state where the cooking utensil 1 is inserted into food.

The cooking utensil 1 includes a grip portion 10 and a piercing portion 20. The grip portion 10 may be made of ABS resin, polypropylene resin, or similar materials for the core and covered with elastic plastics such as elastomer or rubber. The piercing portion 20 can be made of stainless steel or other metals or relatively rigid synthetic resins that are easy to pierce food. The cooking utensil 1 is designed to be held by the hand on the grip portion 10 and to pierce and secure food on the piercing portion 20.

The grip portion 10 includes a fixed part 11, a through hole 12, and multiple non-slip parts 13. The grip portion 10 is shaped like a rod, making it easy for the user to hold. The grip portion 10 has a fixed part 11 at one end to which the piercing portion 20 is attached by insert molding to prevent it from coming off. The grip portion 10 has a through hole 12 at the other end. The through hole 12 has a rounded shape with as little angularization as possible on its surface. The grip portion 10 is formed with an elastomer material on its outer surface, giving the through hole 12 elasticity when pressed against a flat surface like a table, preventing damage to the surface. The grip portion 10 has multiple non-slip parts 13 that are convexly arranged on its surface, preventing the hand from slipping when holding the grip portion 10. The area of the through hole 12 can be replaced with a similar convex non-slip part arranged on the surface of the grip portion 10. In this case, the convex non-slip part may be integrally formed with the core or made of the same material as the core and the outer skin.

The piercing portion 20 includes multiple arms 21 on the same plane, multiple reverse hooks 22, a stopper part 23, and a pillar 24. In this embodiment, the arms 21 are plate-shaped, but they are not limited to this shape as long as they can pierce food during use. For example, the arms 21 may also be rod-shaped. The arms 21 extend from a branch point of the pillar 24 located near the middle of the piercing portion 20. In this embodiment, the arms 21 and the pillar 24 are integrally formed, but they can also be formed separately and connected. In this embodiment, the piercing portion 20 has two arms 21.

The reverse hook 22 is provided on part of the tip of the arm 21. The reverse hook 22 includes an inclined portion 221 and a stopper portion 222. The inclined portion 221 forms an acute angle from the tip of the arm 21 towards the pillar 24, and the stopper portion 222 extends in a direction roughly perpendicular to the direction in which the arm 21 extends. The reverse hook 22 allows for easy insertion into the food due to the inclined portion 221 and prevents the food from slipping out by catching on the stopper portion 222.

The reverse hook 22 may have an inclined portion 221 on the outside of the two parallel arms 21, as shown in FIG. 2A, or on the inside of the two parallel arms 21, as shown in FIG. 3A. (In this specification, a reverse hook 22 with an inclined portion 221 on the outside is referred to as an “outward-facing reverse hook 22,” and one with an inclined portion 221 on the inside is referred to as an “inward-facing reverse hook 22”).

The stopper part 23 is provided at the boundary where the arms 21 extend from the pillar 24 near the middle of the piercing portion 20. In this embodiment, the stopper part 23 has an arc shape. However, since the stopper part 23 stops the insertion of the arms 21 into the food by contacting the food's outer surface, its shape is not particularly limited, and it may be linear, for example. The stopper part 23 is positioned to prevent the piercing portion 20 from completely penetrating the food and prevents over-insertion. The stopper part 23 may also include a stepped or inclined portion. For example, a step may be provided to gradually make it more difficult for the food to pass through, thereby stopping the insertion.

The pillar 24 is connected and fixed to the fixed part 11 of the grip portion 10 by insert molding, supporting the arms 21. In this embodiment, the pillar 24 is plate-shaped. However, the pillar 24 is not limited to this shape, as long as it can support the arms 21. For example, the pillar 24 may also be rod-shaped.

When using the cooking utensil 1 of this embodiment, the user holds the grip portion 10 by hand, positions the tip of the reverse hook 22 of the piercing portion 20 against the food, and then inserts the arms 21 into the food to secure the piercing portion 20 inside the food. By inserting and securing the arms 21 into the food, the food can be stably held with one hand, making it easier to cook. When the inclined portion 221 is inclined outward relative to the arms 21, as shown in FIG. 2B, inserting the arms 21 into the food causes the resistance of the food against the inclined portion 221 to generate a force vector that compresses the arms 21 together, narrowing the gap between the reverse hooks 22. Once the insertion stops, the force vector disappears, and the elastic force of the arms 21 causes them to return to their original position, spreading outward. If the cooking utensil 1 is shaken, the vibration further opens the arms 21. As a result, the reverse hooks 22 bite into the food, generating a force that grips the food. On the other hand, when the inclined portion 221 is inclined inward relative to the arms 21, as shown in FIG. 3B, inserting the arms 21 into the food causes the gap between the reverse hooks 22 to widen due to the same mechanism as in FIG. 2B.

Therefore, when dealing with hard foods, using a cooking utensil 1 with outwardly inclined portions 221 makes it easier to insert and prevents the food from slipping off. On the other hand, when dealing with soft foods, using a cooking utensil 1 with inwardly inclined portions 221 and wider arms 21 tends to prevent the food from breaking, make it less likely to slip off, and easier to handle. In this way, the cooking utensil 1 utilizes the elastic force of the arms 21, allowing the reverse hooks 22 to return to their original gap using this force. Additionally, considering the effect of this elastic force, it is preferable to have the pillar 24 plate-shaped, as this makes it easier to align the direction in which the reverse hooks 22 open, making the utensil easier to handle.

Considering the effect of the elastic force on the arms 21, for example, if the arms 21 are made of metal such as stainless steel, the thickness of the plate should be 1.2 mm to 3.0 mm, preferably 1.4 mm to 2.5 mm. The minimum width of the arms 21 should be 1.2 mm to 3.0 mm, preferably 1.2 mm to 2.5 mm. The length of the arms 21 from the tip of the reverse hook 22 to the stopper part 23 should be 30 mm to 150 mm, preferably 30 mm to 120 mm, and more preferably 30 mm to 100 mm.

The above has explained the embodiment of the present invention. The cooking utensil 1 according to this embodiment provides a utensil that can easily pierce food and prevent it from slipping off. The cooking utensil 1 is easy to insert into the food due to the inclined portion 221 of the reverse hook 22 and prevents the food from slipping off due to the stopper portion 222.

It should be noted that the above embodiment is intended to illustrate the gist of the present invention and does not limit the present invention. Various modifications are possible within the scope of the technical concept of the present invention.

### Modified Example 1

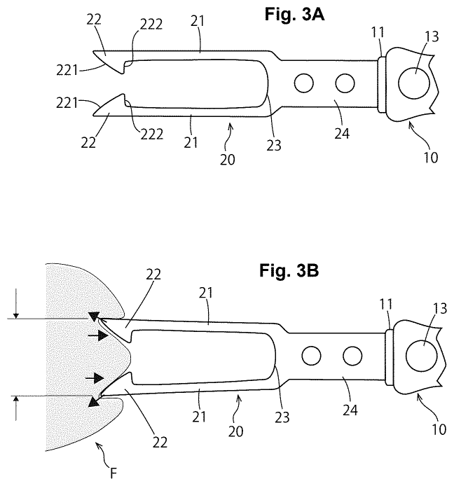

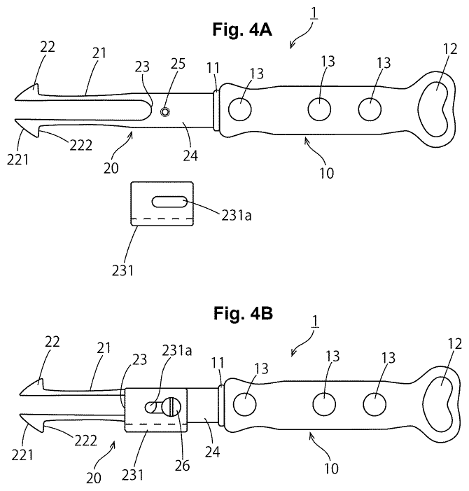

FIG. 4 shows a cooking utensil 1 according to the first modified example of the first embodiment. FIG. 4A is a front view of the cooking utensil 1 and the adjustment auxiliary part 231, and FIG. 4B is a front view of the cooking utensil 1 with the adjustment auxiliary part 231 attached. In this modified example, the stopper part 23 is configured to be adjustable.

The stopper part 23 includes an adjustable auxiliary part 231 that is detachably attached to the piercing portion 20. The adjustment auxiliary part 231 is a hollow, approximately rectangular tube that can be fitted onto the piercing portion 20 and includes a long hole 231a through which a screw can pass. The adjustment auxiliary part 231 is fitted onto the piercing portion 20, and a screw 26 is passed through the long hole 231a and screwed into the screw-retaining part 25 provided on the piercing portion 20. Loosening the screw 26 allows the adjustment auxiliary part 231 to be moved along the length of the long hole 231a, and the screw 26 can be tightened at a desired position to fix it. This allows the position of the stopper part 23 to be made arbitrary, enabling the length of the arms 21 to be adjusted.

### Modified Example 2

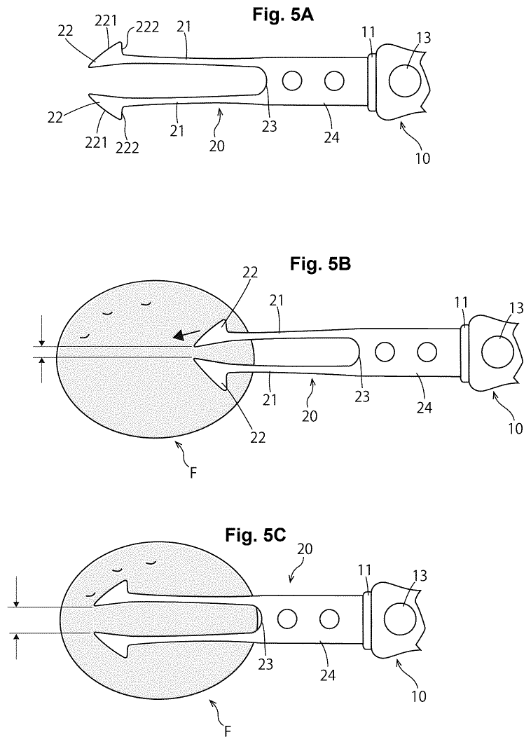

FIG. 5 shows a cooking utensil 1 according to the second modified example of the first embodiment. FIG. 5A is a partial front view of the cooking utensil 1 with the reverse hook 22 angled relative to the arms 21, FIG. 5B is a schematic diagram showing the state when the cooking utensil 1 begins to be inserted into food, and FIG. 5C is a schematic diagram showing the state when the cooking utensil 1 is fully inserted up to the stopper part 23. In this modified example, the tips of the approximately parallel arms 21 are angled slightly towards each other.

In the cooking utensil 1 with outward-facing reverse hooks 22, the tips of the reverse hooks 22 on the approximately parallel arms 21 are angled slightly towards each other. In other words, the piercing portion 20 is formed so that the sides of the approximately parallel arms 21 facing each other are angled slightly towards each other. The tips of the reverse hooks 22 are inclined at an angle of about 0 to 5 degrees relative to the direction in which the arms 21 extend parallel. By tilting the tips of the reverse hooks 22 in this way, it becomes easier to insert the piercing portion 20 into relatively hard foods, such as potatoes, carrots, daikon radishes, and cabbage, as the tips of the reverse hooks 22 come closer together, making it easier to apply force to the tips (FIG. 5B). Furthermore, after inserting the arms 21, the tips of the reverse hooks 22 are forced apart, securing the food more firmly (FIG. 5C).

### Modified Example 3

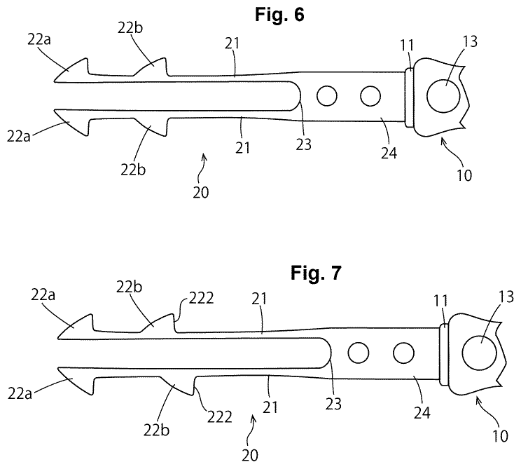

FIG. 6 shows a cooking utensil 1 according to the third modified example of the first embodiment. In this modified example, the arms 21 are longer than in the first embodiment and have reverse hooks 22 not only at the tips but also in the middle. Specifically, the tip portions of the arms 21 are provided with first reverse hooks 22a, and the portions slightly closer to the tips than the middle of the length of the arms 21 are provided with second reverse hooks 22b. The first reverse hooks 22a and second reverse hooks 22b are provided at the same positions on the two facing arms 21. By lengthening the arms 21, the cooking utensil can be used for thicker foods. Additionally, providing two reverse hooks 22 makes it more difficult for the cooking utensil 1 to slip off even when used on thicker foods.

### Modified Example 4

FIG. 7 shows a cooking utensil 1 according to the fourth modified example of the first embodiment. In this modified example, the positions of the second reverse hooks 22b differ from each other. Specifically, the first reverse hooks 22a are positioned at the same location on the tip portions of the two arms 21, with the second reverse hook 22b on one arm 21 positioned slightly closer to the tip than the middle, while the second reverse hook 22b on the other arm 21 is positioned at the middle point of the arm's length. By positioning the second reverse hooks 22b differently, the cooking utensil 1 can be used to prevent slipping when the piercing portion 20 is inserted into soft foods.

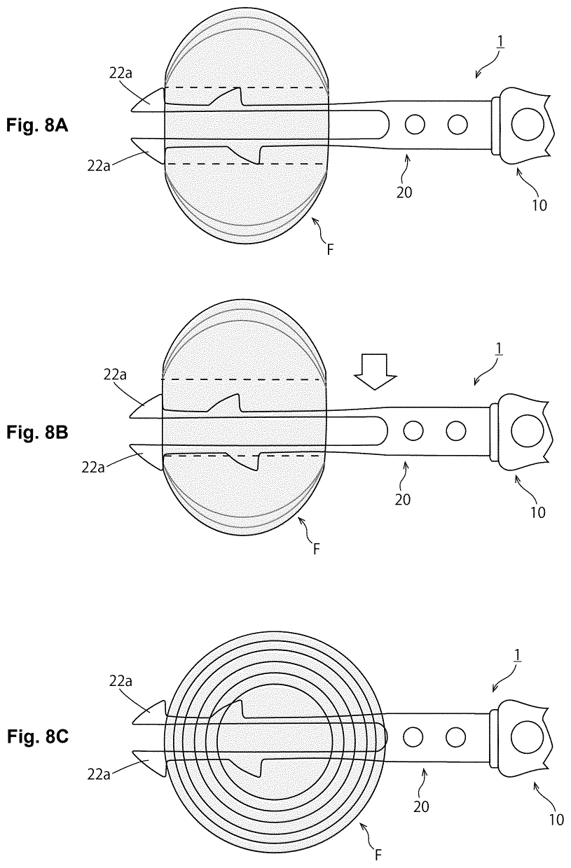

FIG. 8 shows an example of using the cooking utensil 1 according to the fourth modified example. FIG. 8A is a schematic diagram showing the cooking utensil 1 inserted parallel to the fibers of an onion as an example, FIG. 8B is a schematic diagram showing the cooking utensil 1 being pressed and moved perpendicular to the fibers after being inserted parallel to the fibers, and FIG. 8C is a schematic diagram showing the cooking utensil 1 inserted perpendicular to the fibers of the onion. As shown in FIG. 8A, when the first reverse hooks 22a at the tip portions of the arms 21 penetrate the food, the stopper portions 222 of the first reverse hooks 22a catch on the end of the food, and the stopper portions 222 of the differently positioned second reverse hooks 22b catch inside the food, allowing the cooking utensil 1 to secure even relatively soft foods (such as onions and yams). As shown in FIG. 8B, after inserting the arms 21 into the food, the cooking utensil 1 can be further secured and made less likely to slip by pressing and moving the cooking utensil 1 in a direction perpendicular to the direction of insertion (in the direction of the arrow). As shown in FIG. 8C, inserting the arms 21 perpendicular to the fibers of the onion causes the stopper portions 222 of the first reverse hooks 22a to catch on the outside of the food, and the stopper portions 222 of the differently positioned second reverse hooks 22b catch inside the food, making it less likely to slip. Inserting the cooking utensil 1 perpendicular to the fibers of the onion makes it easier to create onion slices.

### Modified Example 5

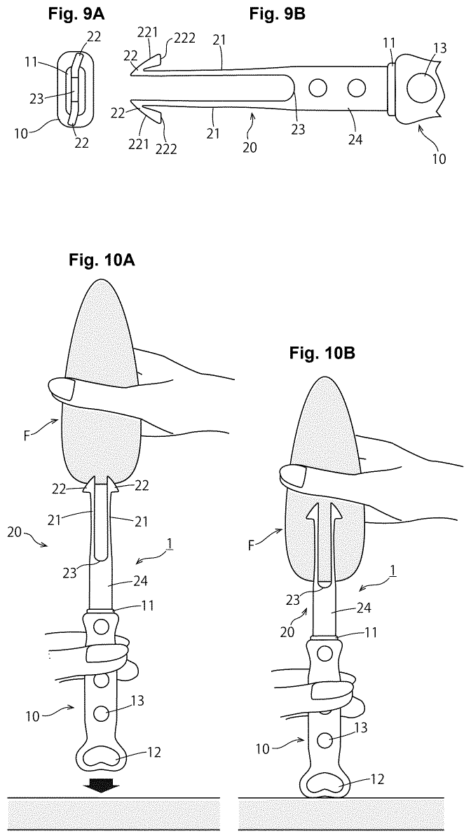

FIG. 9 shows a cooking utensil 1 according to the fifth modified example of the first embodiment. FIG. 9A is a plan view of the cooking utensil 1, and FIG. 9B is a partial front view of the cooking utensil 1. In this modified example, the shape of the reverse hooks 22 of the cooking utensil 1 is different. The reverse hooks 22 are formed so that the stopper portions 222 have a gap between them and the arms 21. Specifically, as shown in FIG. 9B, the stopper portions 222 are inclined at a narrower angle than the inclined portions 221 and connected to the arms 21.

Additionally, as shown in FIG. 9A, the inclined portions 221 of the reverse hooks 22 are twisted relative to the axis of the piercing portion 20. Therefore, one reverse hook 22 is twisted towards the front side of the paper in FIG. 9B, while the other reverse hook 22 is twisted towards the back side of the paper in FIG. 9B.

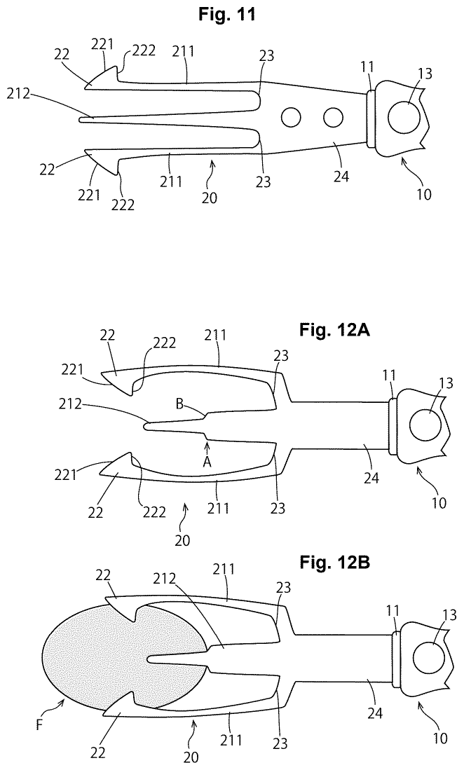

FIG. 10 shows an example of using the cooking utensil 1 according to the fifth modified example. FIG. 10A is a schematic diagram showing a carrot before the cooking utensil 1 is inserted, and FIG. 10B is a schematic diagram showing the state after the cooking utensil 1 is inserted. As shown in FIG. 10A, the tip of the reverse hook 22 is slightly inserted into the carrot, and one hand holds the grip portion 10 by pinching it with the fingertips while the other hand holds the carrot. The grip portion 10 is then strongly struck against a flat surface such as a cutting board or table along with the cooking utensil 1, and as shown in FIG. 10B, the piercing portion 20 is secured in the carrot. The end of the grip portion 10 is formed to be rounded with an elastic material and includes a through hole 12, so the impact is absorbed, preventing damage to the cutting board. Since the reverse hooks 22 are twisted, inserting the piercing portion 20 into the carrot causes the tips of the two reverse hooks 22 to come closer together, and finally, the elastic force of the arms 21 causes them to spread, allowing the piercing portion 20 to securely fix the carrot.

### Modified Example 6

FIG. 11 shows a cooking utensil 1 according to the sixth modified example of the first embodiment. In this modified example, the arms 21 include three arms, one of which does not have a reverse hook 22. Specifically, the arms 21 consist of two arms 211 with outward-facing reverse hooks 22 at their tips and one arm 212 with a pointed tip. The three arms 211, 212 are arranged in a fork-like manner. The middle arm 212 is formed to be longer than the other two arms 211 and gradually widens from the tip towards the stopper part 23. By forming the middle arm 212 to gradually widen, the force exerted when inserting the arms 21 into the food is increased, preventing over-insertion. This is particularly effective in preventing over-insertion into small foods. Additionally, since the middle arm 212 is slightly longer than the other arms 211, it makes initial contact with the food, making it easier to position the utensil. Note that the middle arm 212 may be formed shorter than the other arms 211 to prevent over-insertion.

FIG. 12 shows a modification of the sixth modified example. FIG. 12A is a front view of the piercing portion 20, and FIG. 12B shows an example of its use. In this modified example, the pointed middle arm 212 has a step and is formed shorter than the other arms 211. Specifically, as shown in FIG. 12A, the pointed middle arm 212 is formed shorter than the other arms 211, with the width gradually increasing from point A, roughly in the middle of its length, towards the stopper part 23. Therefore, the middle arm 212 has a step B, with a difference in width between the tip and point A, and the portion from point A to the stopper part 23. The inward-facing reverse hook 22 on the arm 211 has a curve that bulges outward, using the middle arm 212 as the axis. The piercing portion 20 of this modified example allows the reverse hook 22 to move along the outer surface of the food as the inclined portion 221 advances along the food's outer surface, gradually spreading the arms 211. As the tip of the middle arm 212 contacts the food and continues to be inserted, the force exerted by the tip of the middle arm 212 is reduced by the step B, and further reduced by the stopper part 23, preventing over-insertion when using the cooking utensil 1 on small foods. The arms 211 can be pushed into the food from the outside when the middle arm 212 stops. As shown in FIG. 12B, the cooking utensil 1 of this modified example can be used for foods with curved outer shapes, such as apples, lemons, plums, and garlic.

### Embodiment 2

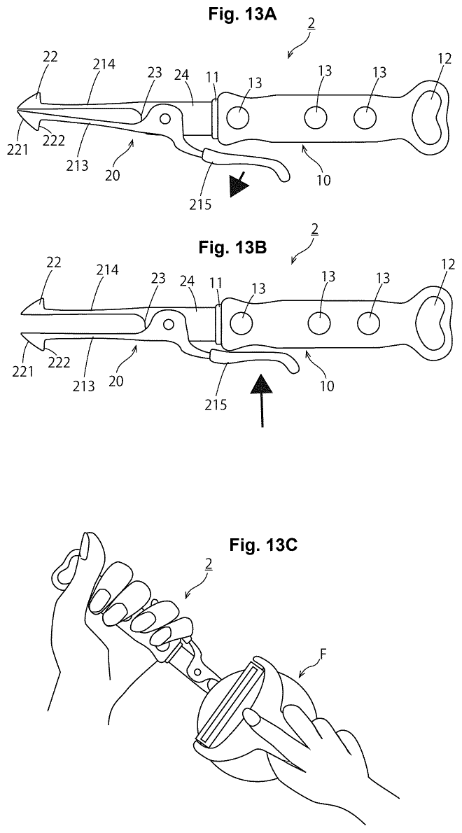

FIG. 13 shows an example of a cooking utensil 2 according to the second embodiment of the present invention. FIG. 13A shows the front view of the cooking utensil 2 with the tips of the arms 21 closed, FIG. 13B shows the front view of the cooking utensil 2 with the tips of the arms 21 open, and FIG. 13C shows a schematic diagram of an example of the use of the cooking utensil 1. In this embodiment, the arms 21 include a first arm 213 and a second arm 214, with the first arm 213 being rotatable relative to the second arm 214. Note that when it is not necessary to distinguish between the first arm 213 and the second arm 214, they will be collectively referred to as the arms 21.

The first arm 213 is rotatably attached to the pillar 24, to which the second arm 214 is attached. The first arm 213 is attached to the second arm 214, for example, with a screw. However, the method of attachment is not particularly limited as long as it allows for rotation. Additionally, the first arm 213 and the second arm 214 may be connected via an elastic member (such as a spring), allowing the tips of the reverse hooks 22 to be biased towards each other.

The first arm 213 includes a lever 215 on the side opposite the direction in which the arm with the reverse hook 22 extends. As shown in FIG. 13A, when the tips of the arms 21 are closed, the lever 215 is positioned with a gap between it and the grip portion 10. By gripping the grip portion 10 together with the lever 215 and moving the lever 215 towards the grip portion 10, the tips of the reverse hooks 22 open.

In the cooking utensil 2 of this embodiment, the piercing portion 20 is inserted into the food with the tips of the reverse hooks 22 aligned. At this time, since the inclined portions 221 face outward, the tips of the reverse hooks 22 are aligned as the piercing portion 20 is inserted into the food. After inserting the piercing portion 20, gripping the lever 215 causes the tips of the reverse hooks 22 to open, allowing the stopper portions 222 to catch inside the food, securing the cooking utensil 1 in place.

The lever 215 is driven until the arms 21 are approximately parallel.

Note that in this embodiment, the tips of the reverse hooks 22 are aligned by the spring force, but the structure may be configured so that the spring force opens the tips of the reverse hooks 22, and gripping the lever 215 aligns the tips of the reverse hooks 22. In this case, the piercing portion 20 is inserted into the food while gripping the lever 215, and once the piercing portion 20 is inside the food, releasing the lever 215 causes the tips of the reverse hooks 22 to open and secure the piercing portion 20 inside the food.

The second embodiment of the present invention has been described above. In this embodiment, the cooking utensil 2 allows for the position of the arms 21 to be adjusted within the food, further securing the piercing portion 20 inside the food by making the first arm 213 rotatable relative to the second arm 214, enabling the tips of the piercing portion 20 to open and close.

Additionally, as shown in FIG. 13C, the food can be stably held, allowing it to be shaved with a peeler or similar tool in the opposite direction to the hand holding the food, thereby preventing injury.

Note that the cooking utensil 2 may include a locking mechanism to fix the position of the lever 215, allowing the distance between the arms 21 to be widened or narrowed by gripping the lever 215.

### Modified Example 1

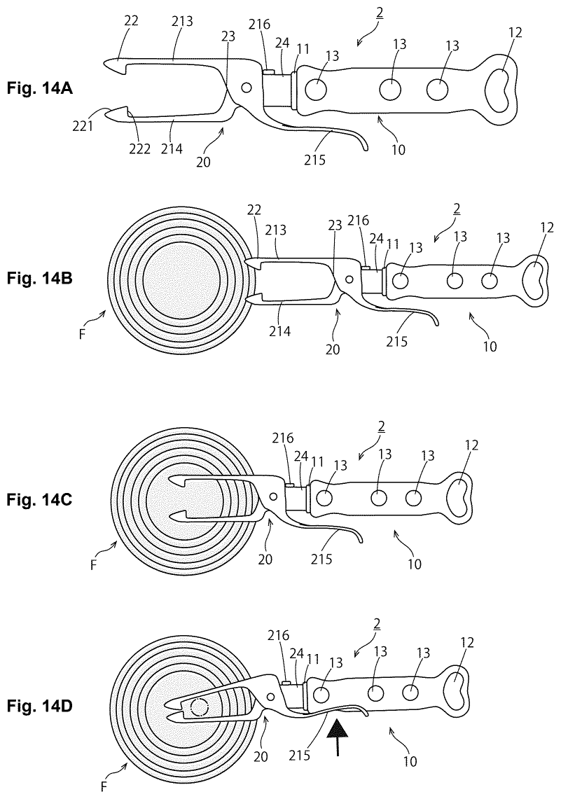

FIG. 14 shows a cooking utensil 2 according to the first modified example of the second embodiment. FIG. 14A is a front view of the cooking utensil 2 with the tips of the arms 21 open, and FIGS. 14B to D show an example of the use of the cooking utensil 2. In this modified example, a stopper 216 is provided to limit the rotation of the first arm 213, and the arms 21 intersect at the part where the first arm 213 is fixed to the second arm 214 with the lever 215.

The stopper 216 is provided to prevent the first arm 213 from rotating more than necessary. In this modified example, the stopper 216 is positioned so that the reverse hooks 22 are open when the first arm 213 and the second arm 214 are approximately parallel. With the reverse hooks 22 open, the piercing portion 20 is inserted into the food, and gripping the lever 215 fixes the piercing portion 20 inside the food. In this modified example, since the reverse hooks 22 are outward-facing, inserting the reverse hooks 22 into the food causes the two reverse hooks 22 to open outwards. In this state, gripping the lever 215 moves the arms 21 so that the tips of the reverse hooks 22 close, causing the stopper portions 222 to catch and secure the piercing portion 20 inside the food.

### Modified Example 2

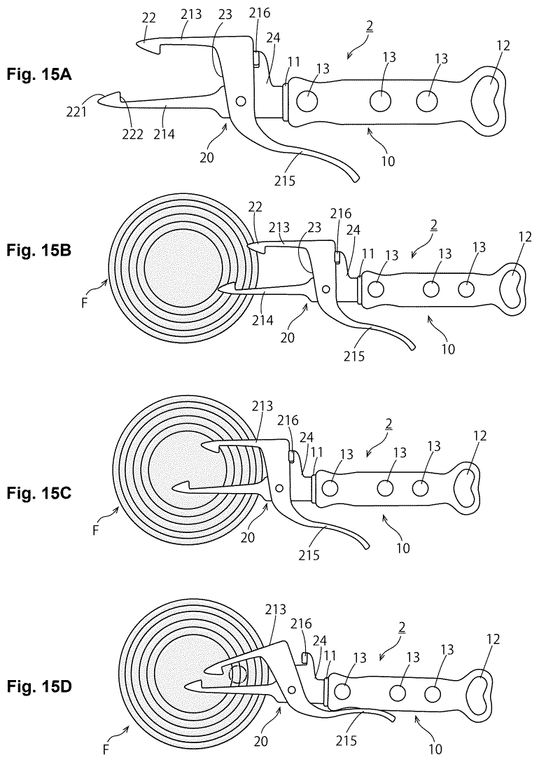

FIG. 15 shows a cooking utensil 2 according to the second modified example of the second embodiment. FIG. 15A shows the state where the tips of the arms 21 are open, and FIGS. 15B to D show an example of the use of the cooking utensil 2. In this modified example, the lengths of the first arm 213 and the second arm 214 are different.

In this modified example, the first arm 213 is shorter than the second arm 214. By varying the lengths of the arms 21, as shown in FIG. 15B, the second arm 214 makes initial contact with the food, making it easier to position, and since the second arm 214 first enters the food, it guides the first arm 213 into the food.

By inserting the second arm 214 into the food, then inserting the first arm 213 into the food, and squeezing the lever 215 to bring the first arm 213 and the second arm 214 closer together, the fibers of the food or similar material become clamped between the two arms 21, where the stopper portion 222 catches and secures the food.

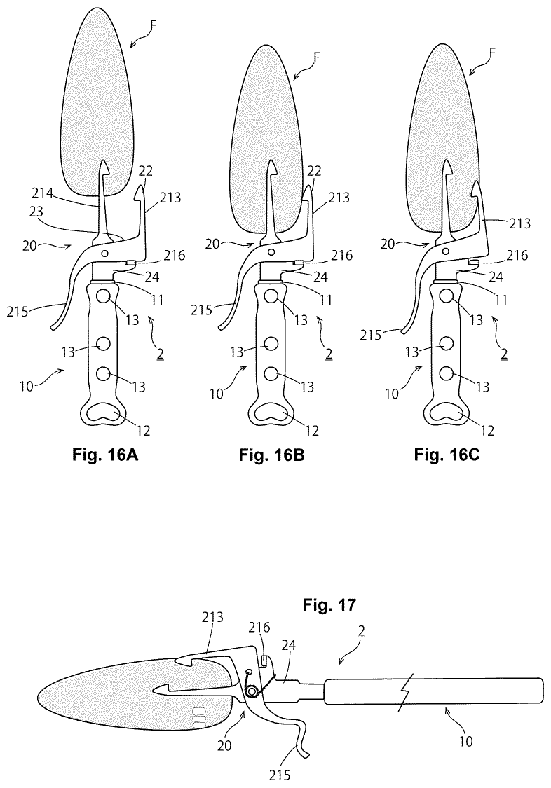

FIG. 16 shows another example of using the cooking utensil 2 according to Modified Example 2. As shown in FIGS. 16A and B, the second arm 214 is inserted into the approximate center axis of the food, and the first arm 213 is brought into contact with the outer circumference of the food. In this state, squeezing the lever 215 moves the first arm 213 and the second arm 214 in the direction of closing, causing the reverse hook 22 of the first arm 213 to pierce the side of the food (FIG. 16C). Since the food is clamped and fixed from both the inside and outside by the two arms 21, the food does not fall off even when the cooking utensil 2 is rotated, making it usable not only when processing food with a peeler but also when cooking food, such as barbecuing. In this case, it is preferable that the lever 215 is fixed in place by a locking mechanism or similar.

### Modified Example 3

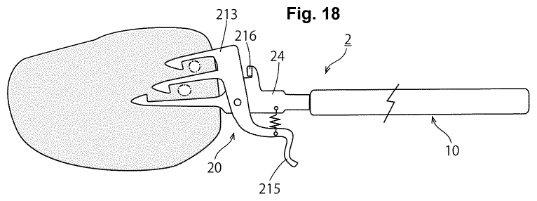

FIGS. 17 and 18 show an example of the cooking utensil 2 according to Modified Example 3 of the second embodiment. In this modified example, the grip portion 10 is elongated, and the rotation of the first arm 213 is spring-loaded towards the state of approaching the second arm 214. The lever 215 is configured to open the first arm 213 and the second arm 214 by pressing it with a finger in the direction away from the grip portion 10. The first arm 213 is spring-loaded, such as with a coil spring, to close the gap between the first arm 213 and the second arm 214. However, any mechanism that allows the gap to close between the first arm 213 and the second arm 214 would be acceptable, not necessarily a coil spring. Since the first arm 213 and the second arm 214 are fixed in a closed state, the food does not fall off even when the cooking utensil 2 is rotated, making it usable not only when processing food with a peeler but also when cooking food, such as barbecuing.

In FIG. 17, the second arm 214 is inserted into the core of corn, and the first arm 213 is pressed from the outside. Therefore, even when the hand is released from the lever 215, the cooking utensil 2 remains fixed to the corn, so the corn does not fall off even when the cooking utensil 2 is rotated.

In FIG. 18, the cooking utensil 2 can be used on foods that are soft but firm to pierce, such as raw meat, because the first arm 213 branches into two parts. The first arm 213 may include not just one arm but multiple arms that work in conjunction with each other, such as opposing the first arm 213.

### Modified Example 4

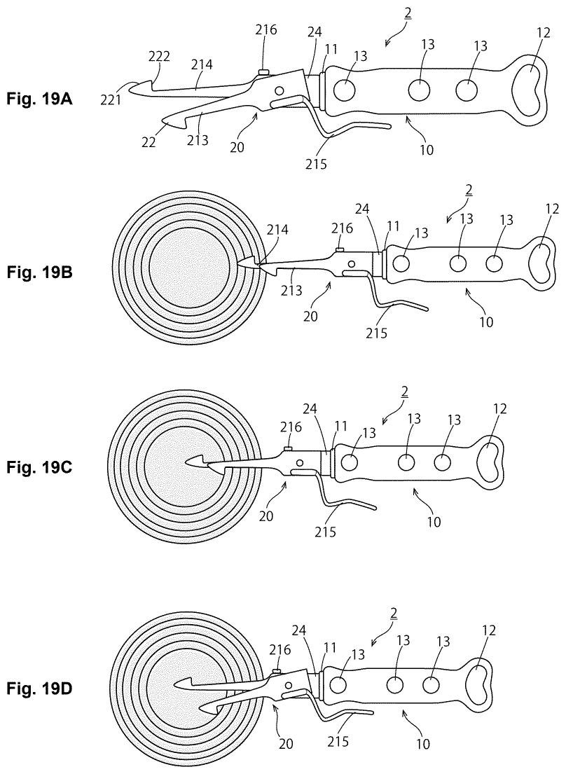

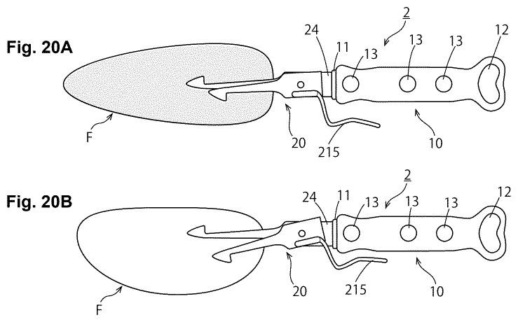

FIGS. 19 and 20 show an example of the cooking utensil 2 according to Modified Example 4 of the second embodiment. FIG. 19A shows the state where the tips of the arms 21 of the cooking utensil 2 are open, and FIGS. 19B to 19D show an example of the use of the cooking utensil 2. In this modified example, the first arm 213 is rotatably fixed to overlap the second arm 214. Squeezing the lever 215 causes the reverse hook 22 of the first arm 213 to rotate away from the second arm 214. As shown in FIGS. 19B to 19D, after inserting the piercing portion 20 into the food with the first arm 213 and the second arm 214 overlapped, squeezing the lever 215 opens the first arm 213 and the second arm 214, fixing the food in place. Since the food is inserted into the food with the two arms 21 overlapped, it is easy to insert and firmly fix even hard foods like carrots shown in FIG. 20A or soft foods like raw meat shown in FIG. 20B.

The embodiments of the cooking utensil according to the present invention have been described above, but these are merely examples of the invention and do not limit the invention. The present invention includes combinations of the above embodiments and their modifications, as well as various other modifications. Various additions, changes, and partial deletions can be made without departing from the conceptual thought and spirit of the present invention as defined in the claims and their equivalents.

### EXPLANATION OF REFERENCE NUMERALS

1, 2: Cooking Utensil
10: Grip Portion
11: Fixed Part
12: Through Hole
13: Non-slip
20: Piercing Portion
21: Arm
22: Reverse Hook
22a: First Reverse Hook
22b: Second Reverse Hook
23: Stopper Part
24: Pillar
25: Screw Retaining Part
26: Screw
211, 212: Arm
213: First Arm
214: Second Arm
215: Lever
216: Stopper
221: Inclined Portion
222: Stopper Portion
231: Adjustment Auxiliary Part
231a: Long Hole
A: Approximate Middle Part
B: Step
F: Food

1. A cooking utensil comprising:
a grip portion held by the user; and
a piercing portion connected to the grip portion and configured to pierces food,
wherein the piercing portion has a plurality of arms on the same plane, with at least one of the arms having a reverse hook at its tip,
the reverse hook comprising an inclined portion forming an acute angle from the tip of the arm and a stopper portion, and wherein at least one of the arms is rotatable relative to the other arms within the same plane.

2. The cooking utensil according to claim 1,
wherein the rotatable arm includes a lever on the side opposite to the direction in which the arm extends.
